(19) United States
(12) Patent Application Publication
(10) Pub. No.: US 2021/0268942 A1
(43) Pub. Date: Sep. 2, 2021

(54) ACTIVE SEAT SUSPENSION FAILSAFE OPERATION

(71) Applicant: CLEARMOTION ACQUISITION I LLC, Billerica, MA (US)

(72) Inventors: Pankaj CHOPRA, Watertown, MA (US); Jack A. EKCHIAN, Belmont, MA (US); Ari GORDIN, Medford, MA (US); Mario Flores ALANIS, Cambridge, MA (US)

(73) Assignee: ClearMotion Acquisition I LLC, Billerica, MA (US)

(21) Appl. No.: 17/055,228

(22) PCT Filed: May 14, 2019
(86) PCT No.: PCT/US2019/032154

§ 371 Date: Nov. 13, 2020

Related U.S. Application Data
(60) Provisional application No. 62/671,723, filed on May 15, 2018.

(51) Int. Cl. B60N 2/50; B60N 2/02

(52) U.S. Cl. CPC B60N 2/501; B60N 2/43; B60N 2/0276

(57) ABSTRACT

Embodiments related to active seat suspensions as well as their methods of operation are disclosed. In one particular embodiment, a failure state of an active seat suspension may be detected after which operation of one or more actuators of the active seat suspension may be limited in response to the detected failure state. In another embodiment, a crash or imminent crash of a vehicle may be detected and an active seat suspension may be operated to lower a seat connected thereto to lower the seat toward an underlying portion of the vehicle. In yet another embodiment, operation of an active seat suspension may be limited to reduce a temperature of the active seat suspension when a rate of change and/or a magnitude of a sensed temperature of an actuator of an active seat suspension is greater than a predetermined threshold.

### CROSS-REFERENCE TO RELATED APPLICATIONS FIELD

This application claims the benefit of priority under 35 U.S.C. § 119(e) of U.S. provisional application Ser. No. 62/671,723, filed May 15, 2018, the disclosures of each of which are incorporated by reference in their entirety.

### FIELD

Disclosed embodiments are related to active seat suspensions including failsafe operation.

### BACKGROUND

Vehicles are subjected to various motion inputs as they are operated. For example, as a vehicle is driven down a road, external disturbances may input motions and accelerations into the vehicle. Accordingly conventional vehicles include suspension systems such as passive, semi-active, and/or active suspension systems to mitigate at least a portion of these accelerations and displacements that may be transmitted to a frame of the vehicle. These accelerations and displacements may then be transferred to a cabin of the vehicle in which a vehicle occupant is located and further transferred to the vehicle occupant through a vehicle seat. To help mitigate these accelerations and displacements from being transmitted to a vehicle occupant located within the vehicle cabin, some vehicles may include active seat suspensions that control motion of an associated vehicle seat in one or more translational and/or rotational directions including, for example, heave, roll, and/or pitch, to at least partially mitigate the accelerations and displacements that are transmitted to the seat and occupant.

### SUMMARY

In one embodiment, a method of operating an active seat suspension in a vehicle includes: detecting a failure state of the active seat suspension; and limiting operation of one or more actuators of the active seat suspension in response to the detected failure state.

In another embodiment, an active seat suspension of a vehicle includes at least one actuator constructed to be operatively coupled to a seat to control movement of the seat in at least one direction relative to an underlying portion of the vehicle. The active seat suspension may also include a controller operatively coupled to the at least one actuator. The controller is constructed and arranged to detect a failure state of the active seat suspension, and the controller is constructed and arranged to limit operation of the at least one actuator in response to the detected failure state.

In yet another embodiment, a method of operating an active seat suspension in a vehicle includes: detecting a crash or imminent crash of the vehicle; and operating the active seat suspension to lower a seat connected to the active seat suspension toward an underlying portion of the vehicle in response to the detected crash or imminent crash of the vehicle.

In still another embodiment, an active seat suspension of a vehicle includes at least one actuator constructed to be operatively coupled to the seat to control movement of the seat in at least heave, and a controller operatively coupled to the at least one actuator. The controller is constructed and arranged to detect a crash or imminent crash of the vehicle, and the controller is constructed and arranged to operate the at least one actuator to lower the seat toward an underlying portion of the vehicle in response to the detected crash or imminent crash of the vehicle.

In another embodiment, a method of operating an active seat suspension in a vehicle includes: sensing a temperature of at least one actuator of the active seat suspension; detecting that a rate of change and/or a magnitude of the temperature is greater than a first threshold; and limiting operation of the active seat suspension to reduce the temperature of the at least one actuator.

In yet another embodiment, an active seat suspension of a vehicle includes at least one actuator constructed to be operatively coupled to a seat to control movement of the seat in at least one direction relative to an underlying portion of the vehicle, a sensor that senses a temperature of the at least one actuator, and a controller operatively coupled to the sensor and the at least one actuator. The controller is constructed and arranged to limit operation of the at least one actuator when a rate of temperature change and/or a magnitude of a temperature of the at least one actuator is greater than a first threshold.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic front view of one embodiment of an active seat suspension;

FIG. 2 is a flow diagram of one embodiment of a method for operating an active seat suspension;

FIG. 3 is a control diagram of one embodiment of a method for controlling heave of an active seat suspension during a sensor failure;

FIG. 4 is a control diagram of one embodiment of a method for controlling roll of an active seat suspension during a sensor failure;

FIG. 5 is a flow diagram of one embodiment of a method for operating an active seat suspension when a crash or imminent crash is detected;

FIG. 6 is a graph of one embodiment of a method for limiting actuator operating temperature of an active seat suspension system; and

FIG. 7 is a schematic diagram of a control system for implementing the control method illustrated in FIG. 6.

### DETAILED DESCRIPTION

Active seat suspension systems may control motion of a connected seat in one or more directions of operation using one or more actuators. For example, an active seat suspension system may include two or more actuators for controlling motion of the seat in two or more directions including, for example, heave and roll. Depending on the particular system, the actuators may be operated either independently and/or cooperatively with each other to control motion of the seat in the desired directions. However, the Inventors have recognized that an active seat suspension may provide undesirable and/or uncomfortable operation when one or more of the actuators of the active seat suspension are not functioning properly and/or when one or more other types of failure states of an active seat suspension may be present.

In view of the above, the Inventors have recognized the benefits associated with controlling operation of an active seat suspension based at least partly on one or more identified failure states of the active seat suspension. These failure states may either be component failures, sensor failures or errors, operating conditions that exceed predetermined design thresholds, and/or any other applicable type of failure that may lead to undesirable operation of an active seat suspension. Regardless of the particular failure state, once a failure state has been detected, a controller of an active seat suspension may limit operation of one or more of the actuators, and in some cases all of the actuators, of the active seat suspension. Depending on the particular failure state, limiting operation of the one or more actuators may correspond to limiting a force applied by the one or more actuators, limiting a motion range of the one or more actuators, and/or locking operation (i.e. preventing movement) of the one or more actuators.

For the sake of clarity, the embodiments described herein are primarily direct to an active seat suspension that controls the heave and rotation of a vehicle seat. However, embodiments in which the disclosed active seat suspensions are used to control rotation and/or translation of the vehicle seat in a different direction are also contemplated. For example, the disclosed active seat suspension systems may also be used to control a pitch of a vehicle seat.

As used herein, the term “heave” may refer to motion of a seat in a generally vertical direction relative to the vehicle's frame of reference, which in some embodiments herein may be referred to as movement along a vertical-axis of a seat and/or vehicle. For example, when a vehicle is stationary and located on level ground, a vertically oriented axis may extend upwards in a direction that is perpendicular to the level ground. Further, in some embodiments, this vertically oriented axis may also be approximately perpendicular to a direction in which an underlying surface of the vehicle interior generally extends even though a floor of a vehicle interior typically is not flat. In either case, it should be understood that even when a vehicle is no longer located on level ground, terms such as heave, vertical movement, movement along a vertical-axis, and/or other similar terms may refer to movement of the seat in a direction that is parallel to this vertical axis which may remain approximately vertical relative to the vehicle's frame of reference. Thus, a vertical axis of a vehicle and/or seat, as well as the associated types of movement noted above, may be understood to be a vertical axis fixed relative to a reference frame of the vehicle, not a global reference frame.

As used herein, the term “roll” may refer to the rotational motion of a seat about an axis that is parallel to a generally longitudinal axis of the vehicle passing from a front to a rear of the vehicle. In some embodiments, this may be referred to as roll of a seat or rotation of the seat about a longitudinal-axis of the seat, seat base or vehicle. For example, when a vehicle is, not loaded, stationary and located on level ground, a longitudinal axis of the vehicle may pass from a front of the vehicle to a rear of the vehicle in a direction that is generally parallel to the ground. The seat may then rotate, or roll, about an axis that extends in a direction that is parallel to this longitudinal axis of the vehicle. Further, even when the vehicle is not located on level ground, this longitudinal axis still passes from a front of the vehicle to a rear of the vehicle relative to the vehicle's frame of reference regardless of the vehicle's global orientation.

Turning now to the figures various embodiments of an active seat suspension system as well as different methods of operating the active seat suspension system are described in more detail. However, it should be understood that the various components and features described in relation to the figures may be used in any appropriate combination as the disclosure is not limited to only the specific embodiments depicted in the figures.

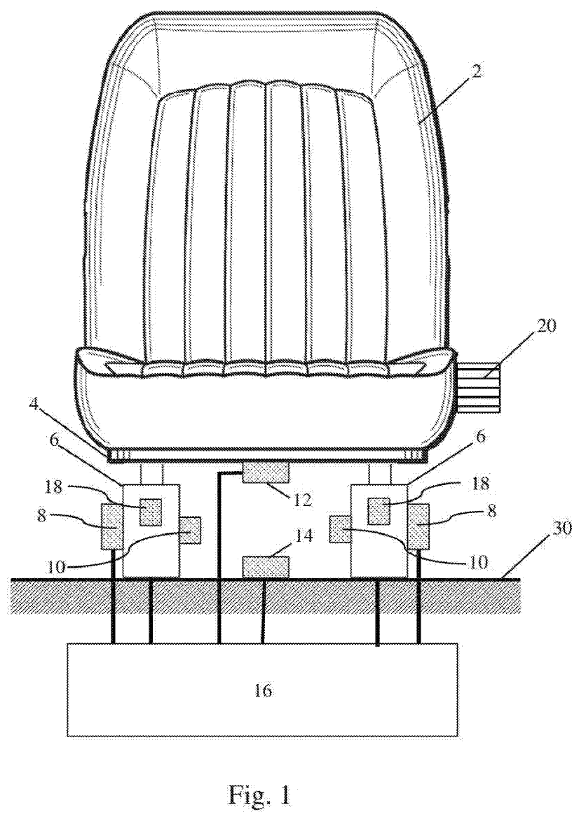

FIG. 1 depicts one embodiment of an active seat suspension. In the depicted embodiment, two actuators 6 are operatively coupled to two portions located on opposing sides of a seat base 4 of a seat 2. The actuators may be operated to displace the associated portions of the seat in a vertical direction relative to the actuators and an underlying portion of the vehicle 30 such as a vehicle interior floor or frame. By cooperatively controlling motion of the two actuators, movement of the seat may be controlled in both heave and roll directions to at least partially mitigate motions and accelerations in these directions from being transmitted to an occupant located in the seat. For example, by extending and/or retracting both actuators by the same amount, the seat may be displaced vertically. Correspondingly, operating the actuators in opposing directions may cause the seat to roll in a desired direction. Combinations of actuator operation where different amounts of displacement are applied to the seat in various directions may result in movement in both the heave and roll directions. Examples of specific active seat suspension designs as well as more detailed methods of operating such an active seat suspension are provided in U.S. patent application Ser. No. 15/953,191 filed on Apr. 13, 2018 and entitled Active Seat Suspension Systems Including Systems with Non-Back-Drivable Actuators, the disclosure of which is incorporated herein by reference in its entirety.

While a particular construction for an active seat suspension in which combined movement of two linear actuators is used to control movement of a seat in the heave and roll directions has been depicted in FIG. 1, it should be understood that any appropriate type of active seat suspension capable of controlling movement of an associated seat in one or more directions may be used. For example, the actuators used in an active suspension system may correspond to any appropriate type of actuator including both rotational and/or linear actuators. Additionally, embodiments in which an active seat suspension may include separate actuators to control movement of a seat in two or more different directions are also contemplated. In one such embodiment, a first actuator may be used to control heave of a seat while a second actuator may be used to separately control roll of the seat. Additionally, embodiments in which an active seat suspension may include three or more actuators to control movement of an associated seat in three or more directions are also contemplated. Depending on the particular construction, the three or more actuators may be used to control movement of the seat via cooperative movement of the actuators or the actuators may be arranged such that they may independently control movement of the seat in the three separate directions.

In view of the above, it should be understood that the current disclosure should not be limited to only the specific active seat suspensions depicted in figures and described herein.

To facilitate operation of an active seat suspension, one or more sensors may be associated with the one or more actuators 6, a seat 2, and/or a portion of the vehicle 30. For example, in one embodiment, each actuator may include a position sensor 8 that is configured to sense position information of the actuator. In some embodiments, each actuator may also include one or more associated temperature sensors 18 that are constructed and arranged to measure a temperature of the associated actuator during operation. The active seat suspension system may also include one or more sensors 12 disposed on one or more corresponding portions of the seat 2 and/or seat base 4. Correspondingly, the active seat suspension system may also include one or more sensors 14 disposed on one or more corresponding portions of a vehicle 30 which matter be directly underlying the active seat suspension and/or may be removed from the active seat suspension. The sensors disposed on the seat and vehicle may measure linear and/or rotational accelerations of the seat and vehicle in one or more directions. The above-noted sensors may be operatively coupled to an associated controller 16 that is operatively coupled to the one or more actuators 6 of the active seat suspension. Accordingly, the controller may receive information from the one or more sensors related to the operating states of the vehicle, seat, and/or active suspension system. This information may be used by the controller to determine one or more commands that may be output to the associated actuators of the active seat suspension to control movement of the seat.

As detailed further below in relation to several exemplary embodiments, a controller 16 of an active seat suspension may detect the occurrence of one or more different types of failure states of an active seat suspension using information from the one or more sensors noted above. Depending on the particular type of actuators used to drive the active seat suspension, and the type of detected failure state, the controller may limit either an amount of force and/or displacement output from one or more of the actuators of an active seat suspension using any number of different control methods and systems as detailed further below.

In some embodiments, an active seat suspension may include one or more backdrivable actuators used to control movement of the active seat suspension. When a backdrivable actuator is used, if the controller were to stop operation of an actuator, the force applied to the actuator would cause the actuator to move in a direction corresponding to the applied force. Accordingly, in some embodiments, it may be desirable for each actuator 6 of the active seat suspension of FIG. 1 to include a lock 18 that is configured to prevent (i.e. lock) operation and/or motion of the associated actuator. Each of the locks may be operatively coupled to the controller 16 to selectively move the locks between a locked and unlocked configuration. Further, in one embodiment, the locks may be biased to a locked configuration such that when power is supplied to the lock during normal operation, the lock may be in an unlocked configuration. However, during a failure state, a controller operatively coupled to the lock may terminate application of power to the lock causing the lock to move from the unlocked to the locked configuration. Beneficially, this may also result in the lock defaulting to a locked configuration in the instance of a power failure to the associated actuator. In one such embodiment, the lock may correspond to an electrical solenoid including an interlocking pin and groove arrangement, a friction brake that is biased towards a closed position, and/or any other appropriate type of brake. In embodiments including a solenoid, the solenoid may be held in an open configuration when powered and the solenoid may be biased towards a locked configuration by a magnet and/or spring. Accordingly, when power to the solenoid is terminated the lock may return to the locked configuration. Of course embodiments in which the lock is not biased towards a locked configuration and/or different types of locks are used are also contemplated as the disclosure is not so limited.

In another embodiment, an active seat suspension may include one or more non-back-drivable actuators. In such an embodiment, the movement and force provided by a non-back-drivable actuator may be limited by simply not providing a command and/or power to the actuator. Specifically, since non-back-drivable actuators are constructed to support the expected static and dynamic loads of an associated active seat suspension without being back driven, the actuators may maintain their extension, rotational position, and/or other appropriate type of position even when they are not actively operated. Consequently, a non-back-drivable actuator may be effectively locked in place when they are not operated. Thus, a non-back-drivable actuator may easily be operated such that a force or motion output from the actuator is limited to be within a predetermined range of motion. Alternatively, the actuator may simply not be operated to effectively “lock” operation of the non-back-drivable actuator.

Depending on the particular embodiment, locking a non-back-drivable actuator may correspond to electrical power not being provided to an associated actuator. Alternatively, in instances where a shaft is used to transmit input motion from an associate motor to a transmission system that is non-back-drivable, the shaft may be operatively coupled with a clutch located between the shaft and the transmission component. In some embodiments, the clutch may be biased towards a released configuration. Thus, during normal operation, the clutch may be held in an engaged configuration with the shaft. For example, a powered solenoid or other similar component may be used to hold the clutch in the engaged configuration. The clutch may thus transmit motion from the motor to transmission component when the clutch is located in the engaged configuration. However, when it is desired to lock the actuator in place, power to the clutch may simply be terminated causing the clutch to be displaced into the released configuration decoupling the motor and shaft preventing further displacement of the non-back-drivable actuator to lock the actuator in place.

While particular methods for limiting operation of a non-back-drivable actuator are noted above, in some embodiments a lock may also be included with a non-back-drivable actuator and/or different methods for limiting motion of a non-back-drivable actuator may be implemented as the disclosure is not limited in this fashion.

As the term is used herein, a non-back-drivable actuator may be appropriately designed using combinations of mechanical advantage and friction to support the expected dynamic and static loads of an active seat suspension during normal operation without a substantial amount of backdriven motion. Thus, the actuator may be considered to be effectively non-back-drivable. In one embodiment, a non-back-drivable actuator may include a worm drive with an appropriate worm pitch, worm gear radius, and transmission and/or motor friction to prevent the actuator from being backdriven. However, other types of actuators may also be considered non-back-drivable. For example, harmonic drives may be configured to be non-back-drivable. Additionally, ball screws with a sufficiently high mechanical advantage (i.e. if coupled to another gear reduction such as a belt drive or gear drive) may be considered to be non-back-drivable when coupled with motor friction. Further, conventional lead screws (i.e. a threaded rod in a nut) can be non-back-drivable when designed with sufficient amounts of mechanical advantage and friction. In view of the above, it should be understood that an effectively non-back-drivable actuator may be considered to be any actuator including a sufficient combination of mechanical advantage and friction to support the expected static and dynamic forces during operation of a system without being substantially back driven even when the actuator is not being actively operated. Further, in some embodiments, it may be advantageous to provide increased amounts of mechanical advantage in a non-back-drivable actuator to minimize the amount of friction present in a system to provide the desired non-back-drivable characteristics of the actuator.

As detailed further below, in some embodiments, it may be desirable to limit an amount of force and/or torque provided by one or more actuators of an active seat suspension instead of an amount of output motion. This may be accomplished by controlling the current supplied to the one or more actuators (e.g. using pulse width modulation or other current control method), feedback loops combined with calculated and/or directly measured forces/torques, and/or any other appropriate control method capable of controlling a force/torque applied by the one or more actuators to an active seat suspension.

In some instances, when an active seat suspension enters a failure state, the active seat suspension may be locked in a configuration that is either uncomfortable and/or less desirable for a vehicle occupant seated in the associated seat. For example, a seat might be locked in a rolled orientation and/or a heave location that is either less than, or greater than, a desired heave location for the occupant. In either case, it may be desirable for the active seat suspension to be manually adjustable to a desired configuration even when one or more actuators of the active seat suspension have been locked due to the detection of a failure state of the active seat suspension. Accordingly, as shown in FIG. 1, an active seat suspension may include one or more manual handles 20 that are operatively coupled to the actuators 6 of the active seat suspension. As detailed below, the one or more manual handles may be operated in a number of different ways to facilitate moving the associated seat 2 to a desired position and/or orientation. For example, the manual handle may be a release associated with one or more actuators to manually unlock the actuators prior to manually positioning the seat. Alternatively, the manual handle may be a hand crank, knob, or other similar structure capable of manually driving the actuators to position the seat in a desired position and/or orientation. Specific examples for different types of actuators are provided below.

As noted previously, an active seat suspension may include one or more actuators 6 that are backdrivable as well as one or more associated locks 10 to limit and/or prevent movement of the actuators during a detected failure state. In such an embodiment, one or more manual handles 20 may be actuated by an occupant to disengage the locks 10 associated with the corresponding actuators. Once the locks are moved to the unlocked configuration, the occupant may then manually adjust the position of the seat 2 to a desired configuration, e.g. a desired roll and/or heave position. For example, the active seat suspension may include one or more springs, not depicted, that are arranged to support a base 4 of the seat such that the one or more springs bias the seat to a neutral position when no external forces are applied to the seat and the actuators are unlocked. The occupant may then apply appropriate forces to the seat to move the seat to a desired position and/or orientation, prior to operating the manual handle to move the one or more locks to a locked configuration to lock the seat in the desired position and/or orientation.

In embodiments where an active seat suspension includes one or more non-back-drivable actuators, each actuator 6 may be operatively coupled to a manual handle 20 that may be operated to manually drive the associated actuator in either direction to adjust a configuration of a seat 2. For example, using the embodiment depicted in FIG. 1, an occupant of the seat may operate a manual handle associated with each actuator to adjust the vertical positioning of the associated portions of the seat base 4. By appropriately raising or lowering the opposing portions of the vehicle seat manually, the seat occupant may control both a heave and roll of the seat to be in a desired configuration. Of course while two linear actuators have been depicted in the figure, embodiments different types of actuators are used are also contemplated. For instance, a manual handle may be used to manually drive a rotational actuator of an active seat suspension as well.

It should be understood that while particular arrangements for manually controlling the position of a seat during a failure state of an active seat suspension have been described above, the current disclosure is not limited to only these specific embodiments. Instead, the disclosure should be read broadly to encompass any appropriate arrangement of manually driving or releasing an active seat suspension system to permit a seat occupant to move the seat to a desired position and/or orientation in instances where operation of the active seat suspension may be limited due to the occurrence of one or more types of failure states.

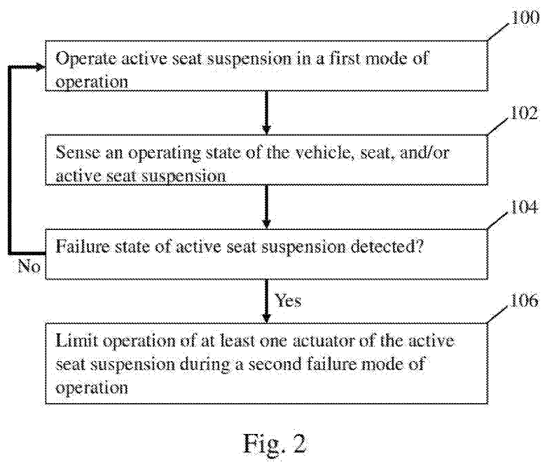

Having described various exemplary components of an active seat suspension, one embodiment of a method of operating an active seat suspension is detailed further in relation to FIG. 2. In the depicted embodiment, the active seat suspension may be operated in a first mode of operation at 100. This first mode of operation may correspond to a normal operating mode of the active seat suspension where the active seat suspension is operated to at least partially mitigate motion and/or accelerations applied to a seat in one or more directions. During operation, a controller of an active seat suspension may receive information from one or more associated sensors related to one or more operating states of the vehicle, seat, and/or active seat suspension at 102. As detailed further below in regards to specific examples, the one or more sensed operating states may be used by a controller of the active seat suspension to detect the occurrence of one or more failure states of the active seat suspension at 104. If a failure state is not detected, the active seat suspension may continue to operate in the first normal mode of operation. However, if a failure state is detected, the controller of the active seat suspension may operate the active seat suspension in a second failure mode of operation at 106. In this second failure mode of operation, the controller may limit operation of at least one actuator of the active seat suspension. Again, in some embodiments, limiting operation of the actuator may correspond to maintaining operation of the at least one actuator within a limited force and/or movement range that is less than a normal force and/or movement range of the actuator. Alternatively, during certain types of failure modes, the controller may simply lock operation of the one or more actuators to prevent movement from being output by the actuators using the various methods and systems described above.

It should be understood that any number of different sensors may be used to measure one or more operating states of a vehicle, seat, and/or active seat suspension. For example, single axis accelerometers, three axis accelerometers, gyroscopes, and inertial monitoring units (IMU's) may be used to measure translational and/or rotational accelerations applied to a seat and/or a portion of a vehicle underlying the seat in one, two, three, and/or any other number of directions. Thermocouples and thermistors may also be used to measure a temperature of one or more actuators, or other appropriate component, of an active suspension system during operation. One or more position sensors such as an absolute position encoder, a relative position encoder, a Hall effect sensor/magnet pair, and other appropriate types of position sensors may be used to measure the positions of the actuators. A current supplied to the one or more actuators during operation may also be sensed in certain embodiments using separate current sensors associated with the individual actuators and/or current sensing/control components built directly into the control circuitry of an active suspension system. Without wishing to be bound by theory, in some embodiments, sensing a current of the actuator may be correlated with a force and/or torque output from the actuator to an associated portion of an active seat suspension.

In some embodiments, information related to the operating states sensed by the one or more types of sensors described above, as well as information derived from the sensed information, may be compared to one another for control purposes. For example, acceleration signals from accelerometers, gyroscopes, and/or IMU's of a seat may be integrated over time to provide a translational velocity, a rotational velocity, a translational position, and/or an angular position of a seat over time. These measurements may be done either using an absolute reference frame and/or may be done relative to acceleration signals of a seat measured relative to an underlying portion of the vehicle. For example, accelerations applied to both the vehicle and the seat may be taken into account when determining an acceleration, velocity, and/or position of the vehicle seat relative to the underlying portion of the vehicle. In either case, in some embodiments, it may also be desirable to separately take the first and/or second derivatives of position signals provided by position sensors associated with the one or more actuators to determine at least one of a translational velocity, a rotational velocity, a translational acceleration, and/or a rotational acceleration of the seat. As detailed further below, these signals and calculated parameters may be compared to help determine the occurrence of one or more different types of failure states.

The above noted types of sensor signals and operating states of an active seat suspension may be used to determine any number of different failure states. Specific non-limiting examples of failure states are described in further detail below.

During normal operation, when a commanded position and/or force is output to an actuator an expected electrical current, motion, and temperature increase of the actuator may be observed. In instances where the current, motion and/or temperature of the actuator are outside of an expected operational range, this may indicate a failure state of the active seat suspension corresponding to one or more motor failures of the associated actuators. For example, in one embodiment, a motor exhibiting an elevated temperature greater than a threshold temperature, when no force or motion has been commanded, may indicate a short or other type of motor failure. In another embodiment, a motor failure of an actuator may be indicated when a large force is commanded and an actuator does not exhibit an expected temperature increase which may correspond to the actuator not being driven when commanded. In yet another embodiment, a measured current that is greater than, or less than, an expected current for a commanded force and/or displacement of an actuator may also indicate a motor failure of an actuator. A motor failure of the one or more actuators may also be detected when a force and/or position command is output to the one or more actuators but no movement of the actuators is detected using either a corresponding signal from a position sensor of the actuators and/or a translational and/or rotational acceleration signal from a sensor associated with a seat. Of course while specific types of motor failures are detailed above, other types of motor failures and methods of detecting them are also contemplated.

Depending on the type and number of actuators that experience a motor failure, an active seat suspension may limit operation of the one or more actuators in different ways. In the simplest embodiment, a controller of an active seat suspension may simply lock operation of all the actuators of the active seat suspension when a motor failure and/or power loss associated with one, or all, of the actuators is detected. However, in some embodiments it may be desirable to still provide at least some motion mitigation to a seat in one or more directions when one or more actuators of the active seat suspension are still operational. For example, if a first actuator of an active seat suspension were to experience a motor failure the first actuator experiencing the motor failure may be locked in place as detailed above. However, in some embodiments, a separate second actuator, as well as any other operational actuators, may then be driven to control motion of the seat in at least one direction including, for example, a roll direction of the seat. This would be similar to holding one of the actuators 6 of FIG. 1 still while the other actuator is displaced to control a roll of the associated seat. In one such embodiment, after an actuator that has experienced a motor failure is detected, a controller may lock the failed actuator in place and may command the other actuator to rotate the seat to a new neutral position with an effective zero angle relative to a vertical direction defined relative to the vehicle reference frame. The operational actuator may then be operated to control motion of the seat relative to the new neutral position.

The above-noted method of operation may be beneficial since the human body may be more sensitive to a movement in a roll direction as compared to heave. However, it should be understood that depending on the particular type of active seat suspension, the second actuator may be operated to control other appropriate types of motion of the seat as well. Additionally, active seat suspensions including more than two actuators may be controlled in a similar manner where one or more non-functional actuators are locked in place and the remaining functional actuators may be operated to control motion of an associated seat in one or more directions as the disclosure is not limited to any particular active seat suspension.

In another embodiment, a failure state of an active seat suspension may correspond to a reduced force and/or torque capacity of the one or more actuators of the active seat suspension. This particular failure state may be sensed by comparing the sensed acceleration of a seat as compared to an expected acceleration given a particular position and/or force command output to the one or more actuators of the active seat suspension. In some instances, a controller of the active seat suspension may simply lock the one or more actuators in place when a reduced force and/or torque capacity of one or more of the actuators is detected. However, in some embodiments, the controller for an active seat suspension may continue operation with a reduced force and/or torque capacity. For example, a reduced force and/or torque capacity of the one or more actuators experiencing the failure state may be determined using either a sensed current signal and/or accelerations of the associated seat. The controller may then limit the forces and/or torques output from the remaining actuators to match the current operational force and/or torque range of the one or more actuators experiencing the failure state.

In another embodiment, a failure mode may correspond to the presence of an obstruction that limits the movement of one or more components of an active seat suspension. While the presence of an obstruction may be detected in any number of ways, in one embodiment, an obstruction may be detected using spikes in either the motor current of an actuator and/or acceleration signals of an associated seat. When an obstruction is present these current and/or acceleration spikes may occur at the same position during multiple operation cycles of the active seat suspension. For example, a base of the seat, a linkage connecting an actuator to the seat, and/or any other appropriate component of an active seat suspension may contact an obstruction during operation which may suddenly and unexpectedly prevent further movement of the active seat suspension system in the desired direction. This sudden stop in movement of the system may result in a spike in the current drawn by a motor of an actuator associated with the portion of the active seat suspension contacting the obstruction. Similarly, the sudden stop in movement of the active seat suspension may also result in an acceleration spike being applied to the seat which may be sensed by one or more translational and/or rotational acceleration sensors associated with the seat. The occurrence of this current and/or acceleration spike at the same position over two or more actuation cycles may indicate the presence of an obstruction. A controller of the active seat suspension may then enter a failure mode to prevent movement of the active seat suspension that would encounter the obstruction.

When an obstruction is detected by a controller of an active seat suspension, the controller may limit operation of the active seat suspension in several ways. For example, in one embodiment, the controller may simply lock operation of the actuators of the active seat suspension. However, in another embodiment, the controller may lock operation of the one or more actuators associated with portions of the active seat suspension contacting the obstruction. The remaining unobstructed actuators of the active seat suspension may then be operated in a manner similar to that noted above regarding failure of a motor of an actuator such that the unobstructed actuators may still control motion of an associated seat in one or more directions while operation of the obstructed actuators may be locked. In yet another embodiment, the permitted ranges of motion of the actuators associated with the detected obstruction may be limited to avoid contact with the obstruction.

In some embodiments, a failure mode of an active seat suspension may correspond to either a sensor failure and/or an error in the signals received from the one or more sensors of an active seat suspension. For example, in one embodiment, one or more sensors may simply cease to output a signal to an associated controller. In another embodiment, the signals output by the one or more sensors may be compared to one another to confirm the accuracy of the sensed signals over time. For example, position signals from the one or more actuators of an active seat suspension may be compared to the sensed translational and/or rotational acceleration of an associated seat relative to an underlying portion of a vehicle. This may be done either using integrated position or velocity values of the seat from the measured acceleration signals as well as derived velocity and/or accelerations from the measured position signals. If a difference between the compared operating states (i.e. position, velocity, and/or acceleration) is greater than a threshold difference, the active seat suspension may enter a failure mode of operation. In some embodiments, the comparison in the signals may be done over a predetermined time duration to avoid accumulated errors in the compared quantities.

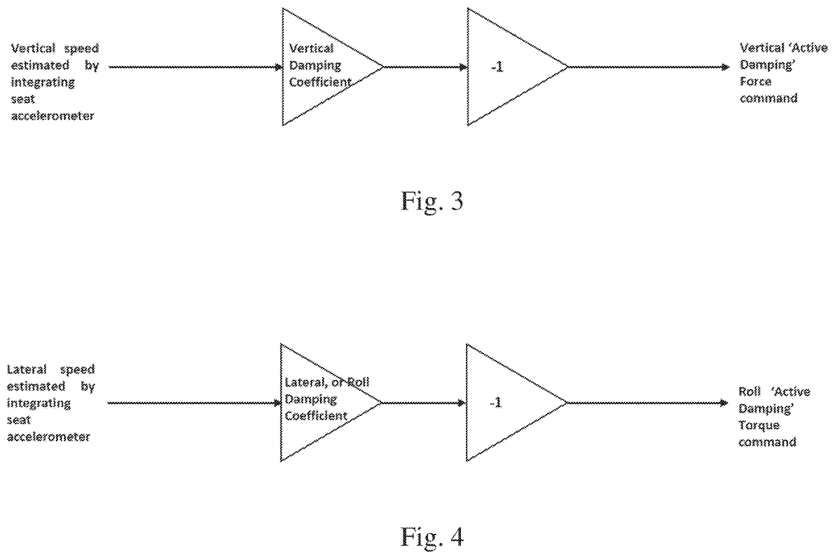

Similar to the above embodiments, when a discrepancy in one or more sensor signals and/or a sensor failure has been detected, an associated controller of an active seat suspension may lock operation of the one or more actuators of the active seat suspension. Alternatively, in another embodiment, the sensor failure may result in the controller of the active seat suspension being unable to determine an absolute position of a seat relative to an underlying portion of the vehicle such as a vehicle floor. In this type of situation, the controller may instead attempt to control motion of the seat by driving the actuators of the active seat suspension to provide active damping forces in one or more directions. For example, in one embodiment, the one or more actuators may be controlled to act like passive dampers attached in the vertical or roll axes of the seat. In one such embodiment, as shown in FIG. 3, a vertical speed of a seat may be estimated by integrating an acceleration signal of the seat in a vertical direction. A controller of the active seat suspension may use this calculated vertical speed along with appropriate vertical damping coefficients to determine a commanded vertical damping force to be output to the one or more actuators of active seat suspension to control movement of the associated seat. Similarly, as shown in FIG. 4, the lateral speed of a seat may be estimated by integrating an acceleration signal of the seat in the lateral direction. A controller of the active seat suspension may then use this calculated lateral speed of the seat along with appropriate lateral damping coefficients to determine a commanded roll or torque to be output to the one or more actuators of the active seat suspension to control movement of the associated seat.

In one embodiment, in a sensor failure condition, a first seat experiencing the sensor failure may communicate with a second seat in the vehicle whose sensor is not failing such that the first seat receives sensor data from the second seat. In such instances, the first seat may reference the second seat's sensor data to return to a neutral position before turning off, to continue operation, or to change modes of operation (i.e., making smaller movements, etc.).

While control of the active seat suspension in the vertical and roll directions is noted above, it should be understood that the concept of measuring accelerations applied to a seat in a particular direction and then controlling the active seat suspension to at least partially mitigate motion in that directions may be applied generally to control movement of a seat in any desired direction.

In yet another embodiment, a failure state of an active suspension system may correspond to the application and/or command of forces, torques, and/or motor currents that are in excess of a predetermined threshold. For example, a component failure or malfunction may result in a discontinuity in the sensed position, acceleration, and/or speed of a seat being input into a controller of an active seat suspension. This discontinuity in the information may cause the controller to command a torque, force, and/or motor current that is greater than a predetermined threshold. These excessive operating states may be interpreted by the software of hardware of the active seat suspension as a failure mode to avoid applying excessive forces and/or torques to a seat as well as an occupant located on the seat. Accordingly, a controller of the active seat suspension system may operate the active seat suspension in a failure mode of operation when such a situation is detected. In one embodiment, the controller of the active seat suspension system may simply not apply the commanded force, torque, and/or motor current to an actuator. Alternatively, the controller may also lock operation of the one or more actuators of the active seat suspension when an excessive force, torque, and/or motor current is commanded or applied. However, in some embodiments, it may be desirable to return the seat to a neutral position prior to locking operation of the one or more actuators. In such an embodiment, the controller of the active seat suspension may not apply the commanded excessive force, torque, and/or motor current. Instead, the controller may command the active seat suspension to move the seat to the neutral position at a predetermined rate. Once the seat is located at the neutral position, the controller of the active seat suspension may lock operation of the one or more actuators to prevent further operation of the system.

In some instances, a mechanical redundancy (e.g., a spring or a system of springs) may be incorporated into the seat such that the seat returns to a neutral position in the event of an electrical failure (e.g., the seat loses power).

In some instances, a vehicle may roll over during an accident. During a rollover event, it may be desirable to prevent operation of an active seat suspension. In such an embodiment, a controller of an active seat suspension may identify the occurrence of a rollover event using: angular accelerations measured by sensors located on a seat and/or a portion of the vehicle; a rollover signal output from a controller of the vehicle to the controller of the active seat suspension over a local network such as a CAN; a sensed orientation of gravity relative to a vehicle reference frame; and/or any other appropriate method of identifying a rollover event. In either case, during a rollover event, the controller of the active seat suspension may either lock operation of the one or more actuators of the active seat suspension and/or may operate the active seat suspension to lower the seat towards an underlying portion of the vehicle.

In some instances, it may be desirable to output an indication of a detected or suspected failure state of an active seat suspension to a vehicle occupant. This indication may be provided using any convenient form. For example, an indication of the failure state may be output to an occupant using: a heads-up display; a dash lamp; an indicator on a graphical user interface of a connected computing device; seat vibrations (assuming the active seat suspension is still at least partially operational); an audible signal from a speaker or other audible source; and/or any other appropriate method for indicating the failure state of the active seat suspension as the disclosure is not limited in this fashion.

After a failure state has ended, it may be desirable for an occupant to be able to reset normal operation of the active seat suspension. For example, a user may be informed of an obstruction of an active seat suspension which may subsequently be removed. The user may then reset the active seat suspension to normal operation using any appropriate user input. Possible user inputs that may be used to reset normal operation of an active seat suspension may include, but are not limited to, a button, a graphical user interface on a touchpad, a connected computing device, a keyboard, a voice recognition unit, and/or any other appropriate type of interface.

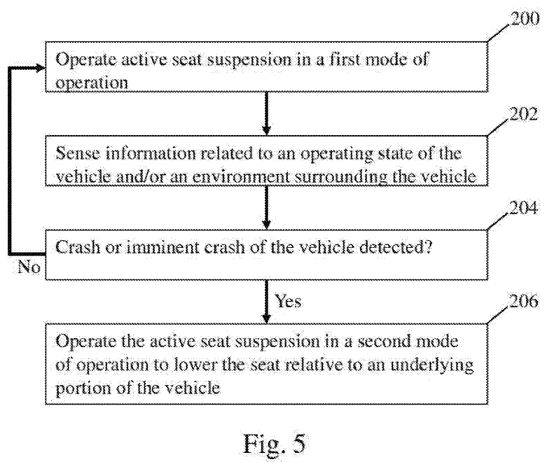

FIG. 5 depicts one embodiment of a method for operating an active seat suspension during a crash of a vehicle. In the depicted embodiment, a controller of an active seat suspension may operate the active seat suspension in a first normal mode of operation at 200. At 202 one or more sensors associated with the controller may sense information related to one or more operating states of the vehicle and/or an environment surrounding the vehicle (e.g. obstacles and/or vehicles within a path of travel or that are likely to intersect a path of travel of the vehicle). This information may be used by the controller of the active seat suspension, and/or a separate controller or computing device associated with the controller of the active seat suspension, to detect either a crash that is occurring or that is imminent at 204. If a crash or imminent crash is not detected, the active seat suspension system may continue to operate in the first normal mode of operation. However, if a crash or imminent crash is detected, the controller of the active seat suspension may control the active seat suspension in a second mode of operation. Specifically, the active seat suspension may lower an associated seat towards an underlying portion of the vehicle in response to the detected crash or imminent crash of the vehicle. In some embodiments, the active seat suspension may also either lock a roll of the seat and/or may roll the seat in a direction that is oriented away from a direction of the detected crash or imminent crash.

Once a crash has occurred, it may be desirable to release, i.e. unlock movement of, an active seat suspension system to permit an occupant to move the seat to a desired position and/or orientation. This may be done by either disengaging one or more locks associated with the actuators of an active seat suspension and/or disengaging one or more transmission components of the non-back-drivable actuators of an active seat suspension. The termination of a crash may either be communicated to a controller of the active seat suspension over a vehicle network such as a CAN, detected using the lack of acceleration other than in a direction of gravity using accelerometers, and/or indicated by input from an occupant of the vehicle using any appropriate type of user interface as noted above.

Any number of different types of sensors and information may be used to sense a crash and/or an imminent crash. For example, translational and/or rotational accelerations of a vehicle may be measured using accelerometers, gyroscopes, and/or MU's to determine the occurrence of a crash or imminent crash. Additionally, information from various types of lookahead sensors (e.g. radar, lidar, optical systems) and other appropriate types of sensors may be used by processed by an appropriate computing device that is configured to detect the occurrence and/or imminent occurrence of crashes. Accordingly, it should be understood that any appropriate type of crash detection system and associated sensors may be used in conjunction with the disclosed active seat suspensions. Further, the crash detection system may either be incorporated with the active seat suspension and/or a signal from a separate crash detection system may be communicated to a controller of an active seat suspension to indicate the occurrence and/or imminent occurrence of a crash event.

Operation of the actuators of an active seat suspension may generate heat that raises a temperature of the actuators over extended durations of operation. Further, during periods of intense actuation of the active seat suspension, the temperatures of the actuators of an active seat suspension may increase towards operational temperature limits that may damage the actuators if exceeded. For example, if a vehicle is driven on very rough road, a relatively high number of cornering events are executed in short duration, and/or the vehicle is subjected to other similar intense driving situations, the actuators may consume more power for active motion compensation. This increased power consumption may cause the actuators to run at much higher temperatures than what may occur during more nominal operation. Accordingly, in some embodiments, it may be desirable to control operation of an active seat suspension to either avoid and/or mitigate excessive amounts of heat generation to maintain a temperature of the actuators of an active seat suspension in a desired operational range.

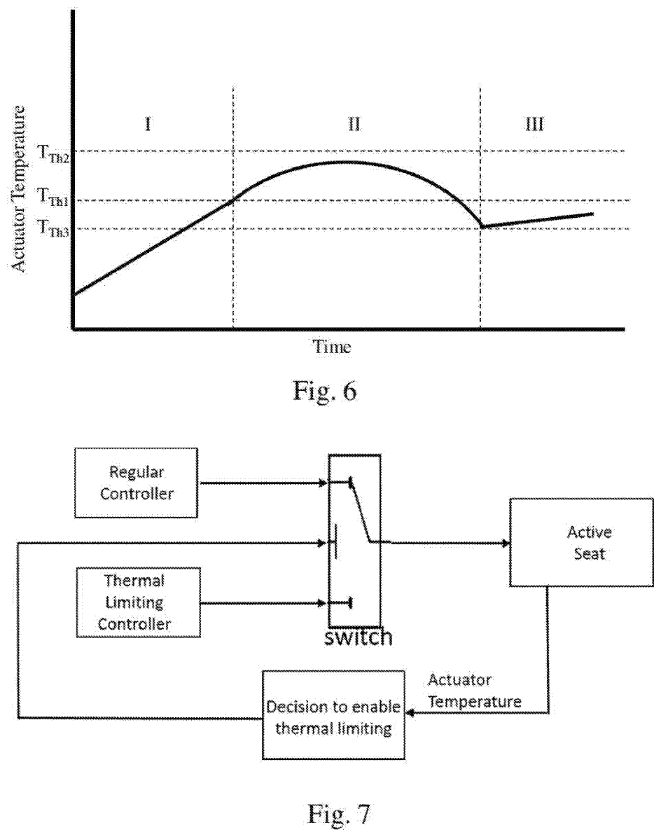

FIG. 6 illustrates one method of operating an active seat suspension to control a temperature of the associated one or more actuators. The graph presents actuator temperature versus time during three different operating modes of an active seat suspension. As noted previously, one or more temperature sensors may be configured and arranged to sense the temperatures of the one or more actuators during operation. During the first time period I, a controller of an active seat suspension may operate the active seat suspension in a first normal mode of operation. As the active seat suspension continues to be operated, a temperature, and in some instances, a rate of temperature change, of an actuator may increase over time. When a temperature and/or a rate of temperature change of one or more of the actuators of an active seat suspension exceed a predetermined threshold, a controller of the active seat suspension may operate the active seat suspension in a second mode of operation to limit and/or reduce a temperature of the one or more actuators. For example, as shown in the figure, when the depicted temperature exceeds a first temperature threshold T_{Th1} during time period II, the controller may operate the active seat suspension in a second mode of operation. In this second mode of operation, the controller of the active seat suspension may limit operation of the one or more actuators to reduce the power consumption of the actuators. By limiting power consumption of the actuators, the temperature of the actuators may be reduced over time. This may be accomplished in a number of ways. For example, a controller of the active seat suspension may limit the current commands output to the one or more actuators by reducing the gains and/or other appropriate control parameters associated with the determined current commands. Alternatively, a controller may command some fraction of the current commands that would be applied during normal operation. However, it should be understood that a controller may implement any other appropriate method for determining a reduced current command to be applied to the one or more actuators as the disclosure is not limited in this fashion.

In one embodiment, a controller of an active seat suspension may either reduce the commanded current to the one or more actuators in a step wise fashion using a preset reduction in a gain or commanded current once a threshold temperature and/or threshold rate of temperature change has been exceeded. Alternatively, the controller may continuously adjust the commanded current as a function of a temperature of the actuators. For example, a gain used to determine a commanded current may be continuously adjusted as a temperature of the one or more actuators increases from the first threshold temperature T_{Th1} to a second threshold temperature T_{Th2} that is greater than the first threshold temperature. In one such embodiment, a reduction factor applied to the gains and/or a commanded output current may be one at the first threshold temperature and zero at the second threshold temperature such that the system may apply a full amount of a normally determined current command may be applied whereas at the temperatures equal to or greater than the second temperature threshold the gain and correspond current command may be zero. The reduction factor may either very linearly and/or non-linearly between the two threshold temperatures.

In response to the reduced current being provided to the one or more actuators of an active suspension system, the temperature of the one or more actuators may initially increase and then subsequently decrease as shown in time period II of FIG. 6. In instances where the temperature of the one or more actuators decreases to a third reset temperature threshold, a controller of the active seat suspension may return to a normal operation mode as shown in time period III. In some embodiments, the third reset temperature threshold may be less than the first temperature threshold. However, embodiments in which the third temperature threshold is equal to the first temperature threshold are also contemplated.

In addition to the above, in some instances, a temperature of one or more actuators an active seat suspension may exceed the above noted second temperature threshold. In one embodiment, in order to avoid damage to the actuators of the active seat suspension, a controller of the active seat suspension may prevent further operation of the active seat suspension. Depending on the particular type of active seat suspension, this may be accomplished by simply not commanding operation of the actuators and/or one or more locks associated with the one or more actuators may be moved to a locked configuration to prevent movement of the seat while operation of the active seat suspension is terminated. After a temperature of the one or more actuators has reduced to a permissible operational temperature, such as a reset temperature threshold (e.g. the third temperature threshold T_{Th3}), normal operation of the active seat suspension may be re-enabled.

FIG. 7 is a schematic diagram of a control system for implementing the control method illustrated in FIG. 6. In the depicted embodiment, a temperature from one or more actuators is used to determine whether or not to enable a thermal limiting control method. In instances where the temperature of the one or more actuators is within a normal operating range, a normal operation control module may be used to control operation of an active seat suspension as shown in FIG. 7. However, in instances where the actuator temperature and/or a rate of change of the actuator temperature is greater than a threshold temperature or threshold rate of temperature change, a controller of the active seat suspension may change operation from the normal operation control module to a thermal limiting control module as described above.

The above-described embodiments of the technology described herein can be implemented in any of numerous ways. For example, the embodiments of controllers described herein may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computer but with suitable processing capabilities, including a Personal Digital Assistant (PDA), a smart phone, a tablet, or any other suitable portable or fixed electronic device.

Also, a computing device and the other systems described herein may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Such computing devices and controllers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of operating an active seat suspension in a vehicle, the method comprising:
detecting a failure state of the active seat suspension; and
limiting operation of one or more actuators of the active seat suspension in response to the detected failure state.

2. The method of claim 1, wherein the active seat suspension includes at least a first actuator and a second actuator, and wherein limiting operation of the one or more actuators includes limiting operation of the first actuator.

3. The method of claim 2, further comprising operating the second actuator to control motion of a seat connected to the active seat suspension in at least one direction.

4. The method of claim 1, wherein limiting operation of the one or more actuators includes locking operation of at least one of the one or more actuators.

5. The method of claim 1, wherein the failure state is at least one of an actuator failure, a sensor failure, vehicle rollover, and an obstruction of the active seat suspension.

6. The method of claim 1, wherein detecting the failure state is based at least partly on at least one or more of an actuator temperature, an actuator current, a seat acceleration, a vehicle acceleration, and an actuator position.

7. An active seat suspension of a vehicle comprising:
at least one actuator constructed to be operatively coupled to a seat to control movement of the seat in at least one direction relative to an underlying portion of the vehicle; and
a controller operatively coupled to the at least one actuator, wherein the controller is constructed and arranged to detect a failure state of the active seat suspension, and wherein the controller is constructed and arranged to limit operation of the at least one actuator in response to the detected failure state.

8. The active seat suspension of claim 7, wherein the active seat suspension includes at least a first actuator and a second actuator, and wherein in at least one operating mode the controller limits operation of the first actuator.

9. The active seat suspension of claim 8, wherein in the at least one operating mode the controller operates the second actuator to control motion of the seat in at least one direction.

10. The active seat suspension of claim 7, wherein each actuator includes a lock configured to lock operation of the at least one actuator, and wherein the controller is operatively coupled to the lock of each actuator to selectively move the lock between a locked and unlocked configuration.

11. The active seat suspension of claim 7, wherein the failure state is at least one of an actuator failure, a sensor failure, vehicle rollover, and an obstruction of the active seat suspension.

12. The active seat suspension of claim 7, further comprising one or more sensors operatively coupled to the controller, wherein the one or more sensors are configured to detect one or more of an actuator temperature, an actuator current, a seat acceleration, a vehicle acceleration, and an actuator position, and wherein the controller detects the failure state based at least partly on information received from the one or more sensors.

13. A method of operating an active seat suspension in a vehicle, the method comprising:
detecting a crash or imminent crash of the vehicle; and
operating the active seat suspension to lower a seat connected to the active seat suspension toward an underlying portion of the vehicle in response to the detected crash or imminent crash of the vehicle.

14. The method of claim 13, further comprising operating the active seat suspension to roll the seat in a direction away from a direction of the crash or imminent crash.

15. The method of claim 13, further comprising detecting the crash or imminent crash using at least one of a translational acceleration of the vehicle, rotational acceleration of the vehicle, and information from a lookahead sensor.

16. An active seat suspension of a vehicle comprising:
at least one actuator constructed to be operatively coupled to the seat to control movement of the seat in at least heave; and
a controller operatively coupled to the at least one actuator, wherein the controller is constructed and arranged to detect a crash or imminent crash of the vehicle, and wherein the controller is constructed and arranged to operate the at least one actuator to lower the seat toward an underlying portion of the vehicle in response to the detected crash or imminent crash of the vehicle.

17. The active seat suspension of claim 16, wherein the at least one actuator is a plurality of actuators, and wherein the controller is constructed and arranged to operate the plurality of actuators to roll the seat in a direction away from a direction of the crash or imminent crash.

18. The active seat suspension of claim 16, further comprising one or more sensors operatively coupled to the controller, wherein the one or more sensors are configured to sense at least one of a translational acceleration of the vehicle, rotational acceleration of the vehicle, and information about an environment surrounding the vehicle.

19. The active seat suspension of claim 18, wherein the at least one sensor comprises at least one lookahead sensor.

20. A method of operating an active seat suspension in a vehicle, the method comprising:
sensing a temperature of at least one actuator of the active seat suspension; detecting that a rate of change and/or a magnitude of the temperature is greater than a first threshold; and
limiting operation of the active seat suspension to reduce the temperature of the at least one actuator.

21. The method of claim 20, wherein the first threshold is a first rate of temperature change threshold, and wherein the rate of change of the temperature is greater than the first rate of temperature change threshold.

22. The method of claim 20, wherein the first threshold is a first temperature threshold, and wherein the temperature is greater than the first temperature threshold.

23. The method of claim 20, further comprising locking operation of the one or more actuators of the active seat suspension if the temperature is greater than a second threshold temperature that is greater than the first threshold.

24. The method of claim 20, wherein the first threshold is a first threshold temperature, and further comprising continuously changing a gain of a current commanded for the one or more actuators at temperatures greater than the first threshold temperature.

25.-30. (canceled)
